(19) United States
(12) Patent Application Publication
(10) Pub. No.: US 2006/0027116 A1
(43) Pub. Date: Feb. 9, 2006

(54) Fabric pattern method and product

(76) Inventor: Jay Salzer, Dallas County, TX (US)

Correspondence Address: W. THOMAS TIMMONS;THE WHITE HOUSE ON TURTLE CREEK, 2401 TURTLE CREEK BLVD, DALLAS, TX, 75219-4760, US

(21) Appl. No.: 10/914,406

(22) Filed: Aug. 9, 2004

(51) Int. Cl. B41F 1/34

(52) U.S. Cl. 101/485

(57) ABSTRACT

A method and its product are disclosed for engraving and printing that would allow one engraving to be used on both 54 inches and 126 inches paper and still be matchable on both 54 inches and 126 inches paper and fabric. The design is engraved starting in the middle of the design and is then engraved in a standard 54 inches repeat. After the paper is printed, half the rolls of paper must be re rolled. Once this is done instead of the paper being matched on the right side, it is matched on the left side with one roll of standard paper and a second roll of re-rolled paper. This allows both rolls of paper to be matched in the center of the design. Now when the paper is joined it will give a roll of 126 inches wide paper. If it is not joined, it will give a roll of 63 inches paper that is in a 54 inches repeat. In this way, both 126 inches and 54 inches fabrics can be printed using the same set of rollers and still be in repeat.

### CROSS-REFERENCE TO RELATED APPLICATIONS

### STATEMENT REGARDING FEDERALLY SPONSORED RESEARCH OR DEVELOPMENT

Not Applicable

INCORPORATION-BY-REFERENCE OF MATERIAL SUBMITTED ON A COMPACT DISC

Not Applicable

### BACKGROUND OF THE INVENTION

1. Field of the Invention

The present invention relates generally to fabric patterns and in one of its aspects to matching fabric patterns.

2. Description of Related Art

For many years the “standard” width for home furnishing and contract fabrics was 54 inches. Due to the width of the fabric, the printed designs for these industries were made to fit the width of the fabric. To clarify this, the fabric is first woven on a loom, and then it is either dyed into a solid color or printed. One of the methods used to print fabrics is called Heat Transfer Printing. In heat transfer printing, the design is first engraved and then printed onto heat transfer paper. The paper is then fed through a heat transfer printing machine that “transfers” the design from the paper onto the fabric. There are two ways that the paper gets printed, screen printing and roller or Gravure printing. The most common paper width for both methods of printing is 63 inches. Even though the paper is 63 inches wide, the designs are engraved in a horizontal repeat that will fit evenly into 54 inches i.e. 54 inches, 27 inches, 13.5 inches, 9 inches etc. Some years ago, The weaving mills got the capability to weave fabrics much wider than 54 inches In fact, they could now weave goods as wide as 126-130 inches. With this in mind Castle Industries developed a method to print these wider fabrics by developing 126 inches screens. This became very popular because the bedspread manufacturers were now able to take this wider fabric and “railroad” it 90 degrees so that the width now became the length. This allowed for seamless bedspreads that took less labor to manufacture. While this was going on, several of the copper roller printers were working on ways to get into this wider width business. They developed at least two different methods. The first was called DDS printing. First they would take the design and engrave it to fit into a 63 inches repeat. Then the would print it on a DDS machine which would take two rolls of paper and print them side by side to cover the full 126 inches of fabric. The second method developed by TransprintsUSA also engraved the design to fit into 63 inches and then they joined the paper to create one seamless 126 inches wide width of paper. Then the paper was fed through a wide with transfer machine that transferred the design onto fabric. In both methods, the designs were usually engraved “railroaded” 90 degrees so that when the bedspread was made the design would run up and down the bed and not across it. One of the drawbacks to this development was that once a design was engraved to fit into a 63 inches repeat, it would no longer be matchable on 54 inches and therefore not be used to print 54 inches fabrics.

### BRIEF SUMMARY OF THE INVENTION

A method according to the present invention is a method of engraving and printing that would allow one engraving to be used on both 54 inches and 126 inches paper and still be matchable on both 54 inches and 126 inches paper and fabric. To do this, the design is engraved starting in the middle of the design. Then it is engraved in a standard 54 inches repeat. Secondly after the paper is printed, half the rolls of paper must be re rolled. Once this is done instead of the paper being matched on the right side, it is matched on the left side with one roll of standard paper and a second roll of re-rolled paper. This allows both rolls of paper to be matched in the center of the design. Now when the paper is joined it will give a roll of 126 inches wide paper. If it is not joined, it will give a roll of 63 inches paper that is in a 54 inches repeat. In this way, both 126 inches and 54 inches fabrics can be printed using the same set of rollers and still be in repeat.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a paper print pattern according to the present invention;

FIG. 2 is a paper match according to the present invention using the fabric print of FIG. 1; and

FIG. 3 is the paper match of FIG. 2 with the top edge trimmed.

### DETAILED DESCRIPTION OF THE INVENTION

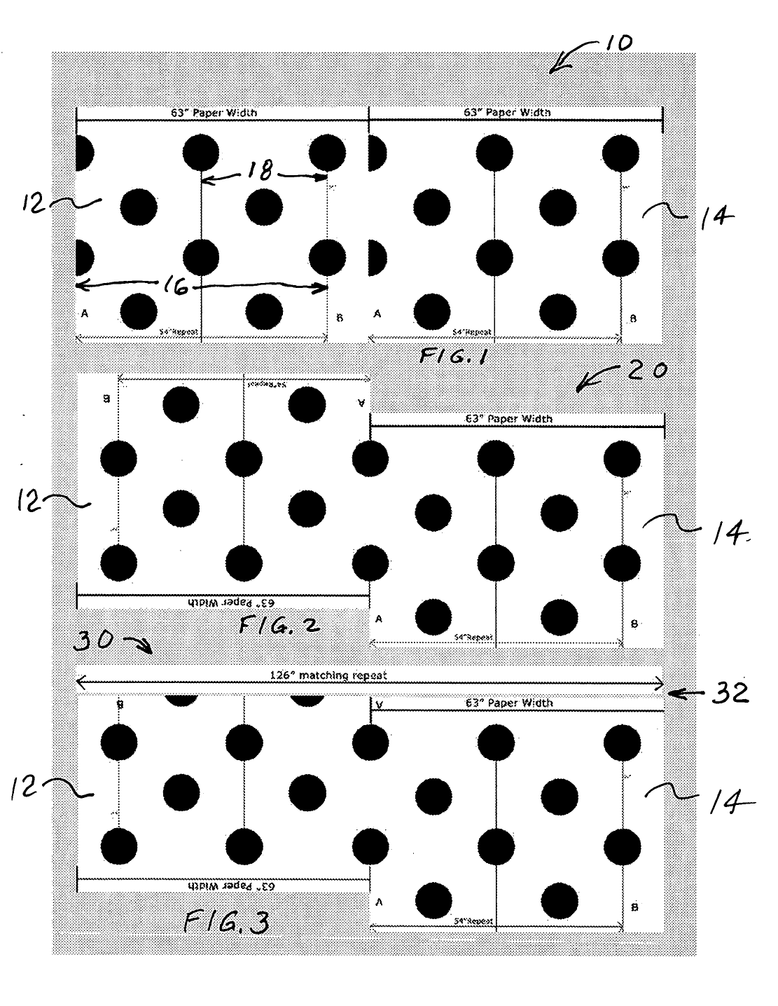

Referring now to the drawing, and in particular to FIG. 1, the paper used for heat transfer is 63 inches wide, the designs are engraved in a horizontal repeat that will fit evenly into 54 inches. As a result, a fabric match 10 includes a first 63 inches wide piece of fabric 12 and a second 63 inches wide piece of fabric 14. The fabric pattern 16 is, however, repeated every 54 inches. In the case illustrated, the pattern 18 is actually repeated every 27 inches.

Referring now to FIG. 2, a method according to the present invention is a method of engraving and printing that would allow one engraving to be used on both 54 inches and 126 inches paper and still be matchable on both 54 inches and 126 inches paper and fabric. To do this, the design is engraved starting in the middle of the design. A paper match 20 according to the present invention, includes a first 63 inches wide piece of fabric 12 and a second 63 inches wide piece of paper 14. A symmetrical fabric pattern 16 is still repeated every 54 inches, but it now begins in the middle of the pattern. In the case illustrated, the pattern 18 is actually repeated every 27 inches. Again, it is engraved in a 54 inches repeat. Secondly, after the paper is printed, half the rolls of paper must be re-rolled. Once this is done instead of the paper being matched on the right side, it is matched on the left side with one roll of standard paper and a second roll of re-rolled paper. This allows both rolls of paper to be matched in the center of the design. Now when the paper is joined it will give a roll of 126 inches wide paper. If it is not joined, it will give a roll of 63 inches paper that is in a 54 inches repeat. In this way, both 126 inches and 54 inches fabrics can be printed using the same set of rollers and still be in repeat. Referring also to FIG. 3, pattern 30 has the top of piece 12 trimmed 32.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A method of engraving and printing heat transfer paper for fabrics which has a symmetrical repeat pattern less than the width of the heat transfer paper, the paper having a first edge and a second edge, comprising the steps of:
printing the pattern, with in the middle of the pattern beginning at the first edge;
aligning the first edge of half of the paper with the first edge of the remaining half of the paper; and
matching the pattern where the first edges align.

2. A method according to claim 1, wherein the step of aligning the first edge comprises the steps of:
rolling a first half of the paper into rolls;
rolling the second half of the paper into rolls in the opposite direction;
unrolling a roll of the first half of the paper; and
unrolling a roll of the second half of the paper adjacent to the unrolled first half of the paper.

3. A method according to claim 1, wherein the width of the paper is about 63 inches wide and the pattern is repeated about every 54 inches.

4. A method according to claim 3, wherein the step of aligning the first edge comprises the steps of:
rolling a first half of the paper into rolls;
rolling the second half of the paper into rolls in the opposite direction;
unrolling a roll of the first half of the paper; and
unrolling a roll of the second half of the paper adjacent to the unrolled first half of the paper.

5. A method according to claim 4, further including the step of trimming the top of the half of the paper that extends the furthest to form a single straight top.

6. Heat transfer paper for fabrics which has a symmetrical repeat pattern less than the width of the heat transfer paper, the paper having a first edge and a second edge, comprising in combination:
a pattern with the middle of the pattern beginning at the first edge;
the first edge of half of the paper aligned with the first edge of the remaining half of the paper; and
wherein the pattern matches where the first edges align.

7. A heat transfer paper according to claim 6, wherein:
a first half of the paper forms rolls;
the second half of the paper forms rolls in the opposite direction;
wherein unrolling a roll of the first half of the paper and unrolling a roll of the second half of the paper adjacent to the unrolled first half of the paper aligns the edges and matches the pattern of the two rolls.

8. A heat transfer paper according to claim 6, wherein the width of the paper is about 63 inches wide and the pattern is repeated about every 54 inches.

9. A heat transfer paper according to claim 8, wherein:
a first half of the paper forms rolls;
the second half of the paper forms rolls in the opposite direction;
wherein unrolling a roll of the first half of the paper and unrolling a roll of the second half of the paper adjacent to the unrolled first half of the paper aligns the edges and matches the pattern of the two rolls.
